(19) United States
(12) Patent Application Publication
(10) Pub. No.: US 2024/0300603 A1
(43) Pub. Date: Sep. 12, 2024

(54) STANCHION GUARD

(71) Applicant: Justin NARDELLA, South Hamilton, MA (US)

(72) Inventor: Justin NARDELLA, South Hamilton, MA (US)

(21) Appl. No.: 18/182,044

(22) Filed: Mar. 10, 2023

(51) Int. Cl. B62J 23/00

(52) U.S. Cl. CPC B62J 23/00; B62K 21/02

(57) ABSTRACT

A guard for a bicycle suspension fork, where the latter includes, e.g., two legs which are joined by a crown. The guard is removably mounted to a leg of the suspension fork. The guard has a first portion and a second portion. The second portion includes two or more circumferential ribs that form a circumferential channel. The channel can receive a removable ligature, e.g., a zip tie. When tightened, the ligature secures the guard to the leg of the suspension fork.

### BACKGROUND

Bicycling is a sport for both amateurs and professionals. Due to irregularities in the road, a bicycle subjects the biker to up/down motions, i.e., motions which are generally perpendicular to the road surface and the direction of travel. A bicycle suspension system dampens the up/down motions experienced by the biker without substantially sacrificing the friction between the tires and road surface. It provides the biker with improved control and comfort. Bicycle suspension is commonly implemented using a front suspension fork.

### BRIEF DESCRIPTION OF DRAWINGS

FIG. 1 is a side view of a bicycle to which a guard is mountable, in accordance with some embodiments.

FIGS. 2A-2B are corresponding front views of a suspension fork assembly of a bicycle, in accordance with some embodiments.

FIGS. 3A-3H are various views of a guard, in accordance with some embodiments.

FIG. 4 is a cross-sectional view of a guard as mounted, in accordance with some embodiments.

FIG. 5A-C are corresponding cross-sectional views of a guard as mounted, in accordance with some embodiments.

FIG. 6 is a left side view of a guard as mounted, in accordance with some embodiments.

### DETAILED DESCRIPTION

The following disclosure provides many different embodiments, or examples of the present subject matter. Specific embodiments will be described in greater detail below, but the embodiments are not limited to these versions or examples which are included to enable a person having ordinary skill in the art to make and use the guard when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

In some embodiments, a guard for a stanchion is a structure mountable to a corresponding lower tube, the latter being a structure included in a leg of a bicycle's suspension fork assembly. The guard prevents damage to a bicycle's suspension fork assembly. In some embodiments, the guard prevents damage to a stanchion, the latter being another structure of the suspension fork assembly, the stanchion being slidably inserted into the lower tube. In some embodiments, the guard protects the stanchion from damage caused by bicycle crashes, transportation, or storage. In various embodiments, the guard is attached to the suspension fork assembly in an upper-mounting arrangement or a lower-mounting arrangement. Once mounted, the guard protects the corresponding portions of the stanchion that are overlapped by the guard, the stanchion being relatively more vulnerable to damage amongst the components of the suspension fork assembly.

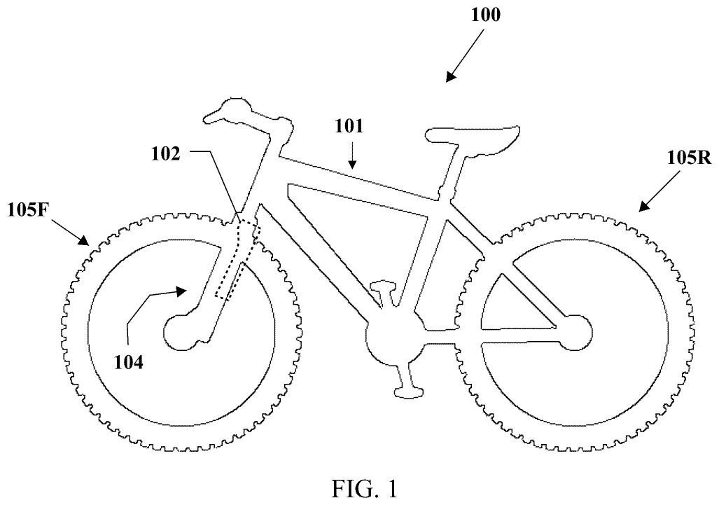

FIG. 1 is a side view of a bicycle to which a guard 102 is mountable, in accordance with some embodiments.

In FIG. 1, a bicycle 100 includes a frame 101, a front suspension fork assembly 104, a front tire 105F and a rear tire 105R. Guard 102 is mountable to assembly 104.

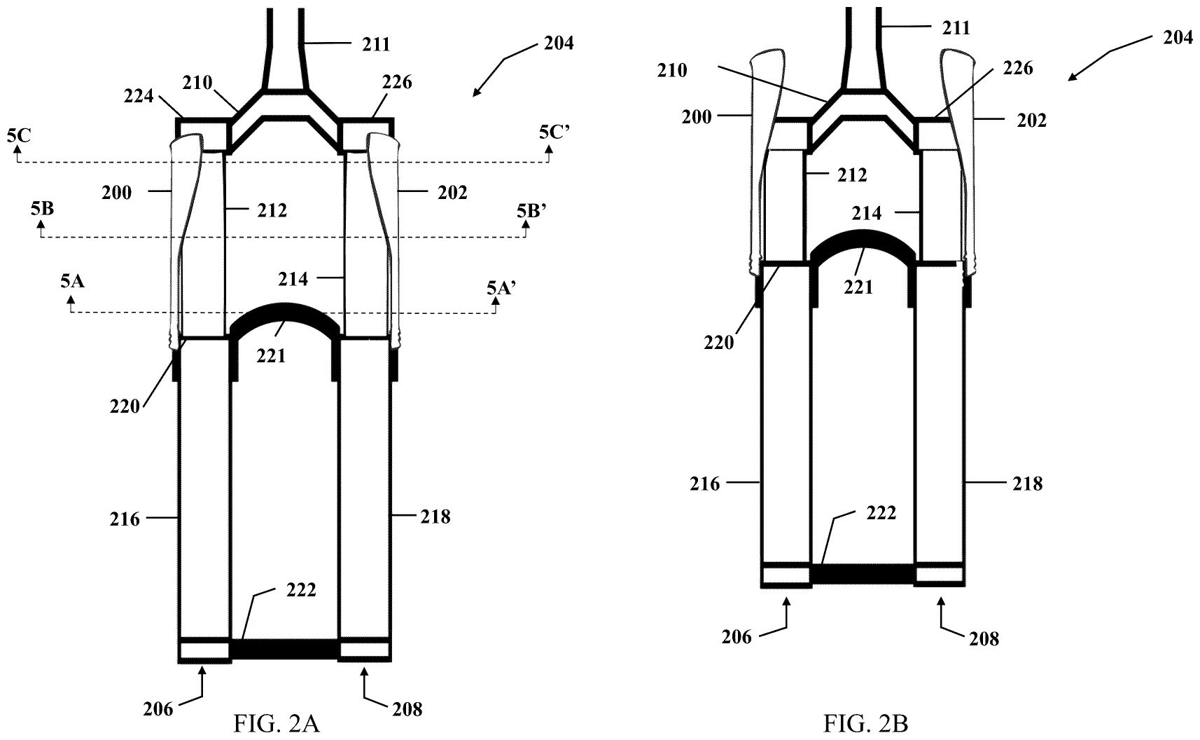

FIGS. 2A-2B are corresponding front views of front suspension fork assembly 204 of a bicycle to which guards 200, 202 are mountable, in accordance with some embodiments.

Assembly 204 is an example of assembly 104 of FIG. 1. Guard 202 is an example of guard 102 of FIG. 1.

FIGS. 2A-2B show the lower-mounting embodiment (which assumes a non-inverted fork architecture), e.g., lower-mount guards 200, 202 mounted on the front suspension fork assembly 205. In FIG. 2A, suspension fork assembly 104 is fully extended (i.e.—not compressed). In FIG. 2B, assembly 204 is compressed.

In FIG. 2A, assembly 204 includes a left leg 206 and a right leg 208 which are joined at the top of assembly 204 by a crown 210. Above crown 210 is a steerer tube 211 which is inserted into a corresponding receiver portion of a bike frame, e.g., frame 101, thereby attaching assembly 204 to the bicycle frame. In some embodiments, steerer tube 211 is referred to as a neck. Each leg 206, 208, includes: upper tubes 212, 214, referred to herein as stanchions 212, 214; and lower tubes 216, 218. In some embodiments, each of lower tubes 216, 218 is referred to as a ‘lowers.’ Stanchions 212, 214 are slidably inserted into corresponding lower tubes 216, 218. At full extension as in FIG. 2A, relatively smaller portions of stanchions 212, 214 are inserted correspondingly into lower tubes 216, 218. During compression as in FIG. 2B, relatively larger portions of stanchions 212, 214 are inserted correspondingly into lower tubes 216, 218.

Each of legs 206 and 208 includes an instance of a gasket 220. An instance of gasket 220 is disposed in a circumferential groove/notch/ledge in lower tube 216 at or near to where stanchion 212 is inserted into lower tube 216. An instance of gasket 220 is disposed in a circumferential groove in lower tube 218 at or near to where stanchion 214 is inserted into lower tube 218. In some embodiments, an instance of gasket 220 is disposed in a notch. In some embodiments, an instance of gasket 220 is disposed in a ledge.

Leg 206 is joined to crown 210 by a shoulder 224. In particular, an end of stanchion 212 is attached to shoulder 224. Leg 208 is joined to crown 210 by a shoulder 226. In particular, an end of stanchion 214 is attached to shoulder 226. Disposed between left and right legs 206, 208 are an arch 221 and an axle 222 that are correspondingly proximal and distal to the instances of gasket 220. Arch 221 and axle 222 help to preserve a parallel alignment of lower tubes 216 and 218 with respect to each other, which facilitates stability. Typically, axle 222 is incorporated into a front wheel assembly and additionally secures the front wheel to the suspension fork.

In FIGS. 2A-2B, assembly 204 provides suspension to the biker and improves control, traction, and comfort. Stanchions 212, 214 travel in and out of the lower outer tubes 216, 218 as the suspension fork assembly 204 compresses and decompresses. Stanchions 212, 214 include a dampening system, e.g., a spring mechanism, that lessens (damps) up/down motions associated with irregularities in the road surface that otherwise would be transmitted unattenuated to the biker by, e.g., legs 206 and 208. However, stanchions 212, 214 are susceptible to damage. Stanchions can be dented or scratched during crashes, transportation, or storage. Stanchion damage can dimmish suspension performance. A damaged stanchion can pose a safety risk to a biker.

Stanchions are also susceptible to damage from dirt and/or water at gasket-stanchion interfaces. At such interfaces, instances of gasket 220 create a seal at locations where stanchions 212, 214 are correspondingly inserted into open ends of lower tubes 216, 218, thereby reducing intrusion of dirt and/or or water into interior spaces of lower tubes 216, 218. Dirt can become trapped between an instance of gasket 220 and stanchion 212 and/or between an instance of gasket 200 and stanchion 214, at which time the dirt becomes abrasive to stanchions 212, 214 and/or increases friction with respect to stanchions 212, 214. Water that seeps between an instance of gasket 220 and stanchion 212 and/or between an instance of gasket 200 and stanchion 214 can, e.g., breakdown lubricant otherwise present therebetween and/or promote corrosion of stanchions 212, 214, either of which can increase friction with respect to stanchions 212, 214. According to another approach, in the hope of preventing such water and/or dirt damage, gaiters are used to cover gasket-stanchion interfaces. However, these gaiters trap dirt and water, contributing to stanchion degradation.

Embodiments of the guards, e.g., guards 200, 202, prevent damage to stanchions, e.g., stanchions 212, 214. In some embodiments, the guard is attached to the suspension fork assembly in an upper-mounting arrangement. In some embodiments, the guard is attached to the suspension fork assembly in a lower-mounting arrangement, e.g., guards 200, 202, in FIGS. 2A-2B. As an example, in light of an outer surface of stanchion 212 being susceptible to radially-inward causes of damage (e.g., impacts) relative to a cylindrical axis of stanchion 212, once mounted, guard 200 protects corresponding portions of stanchion 212 that are overlapped by guard 200.

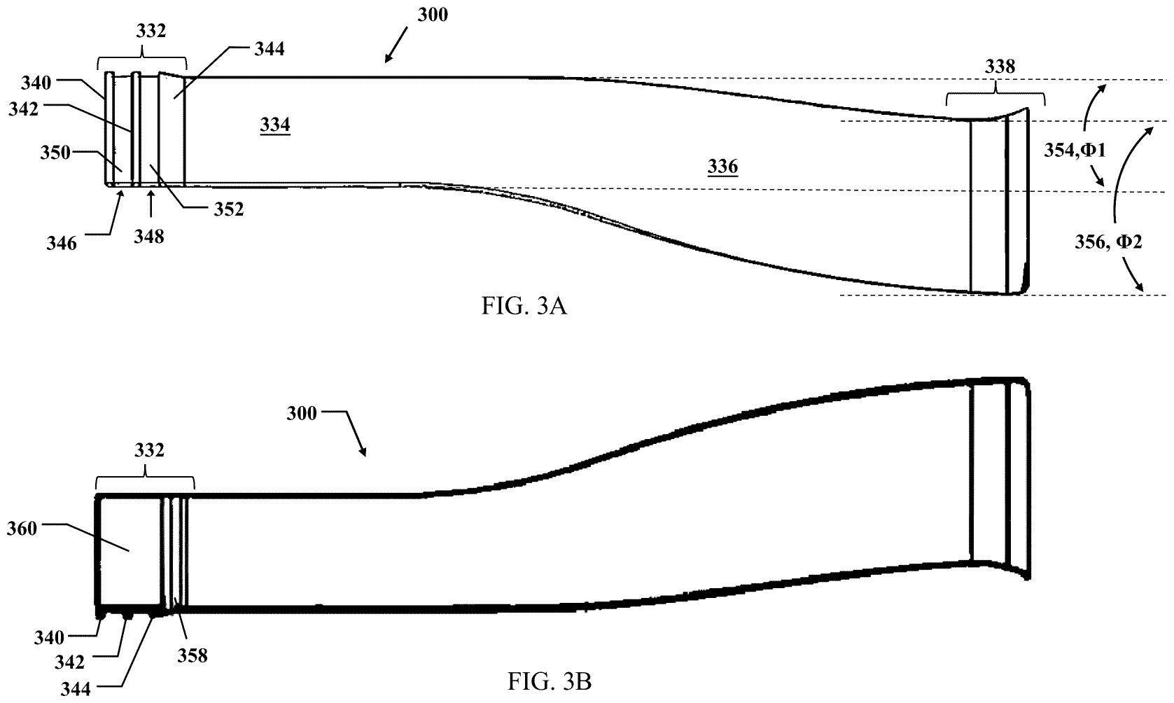

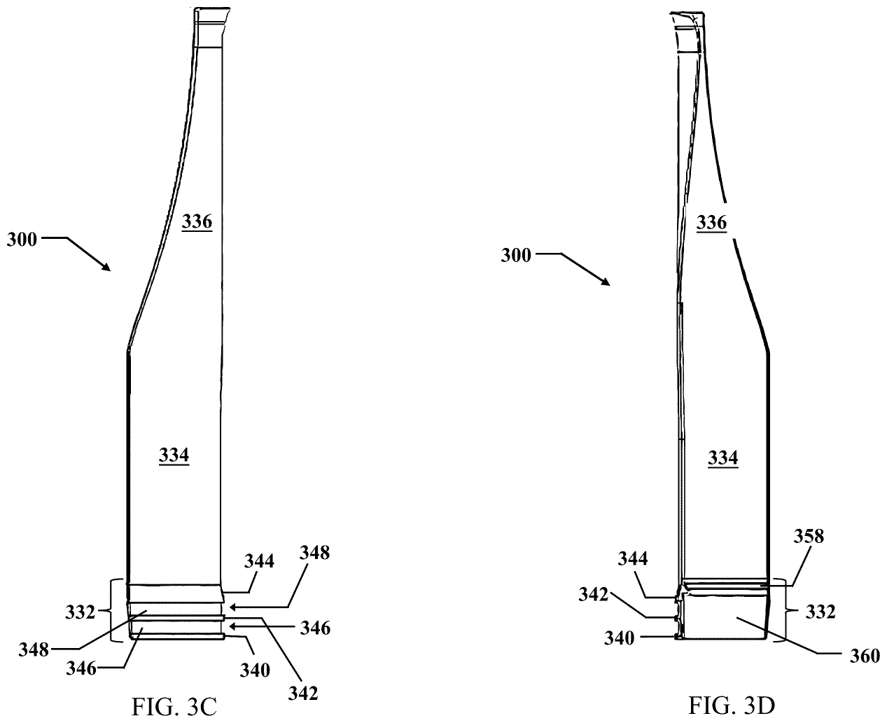

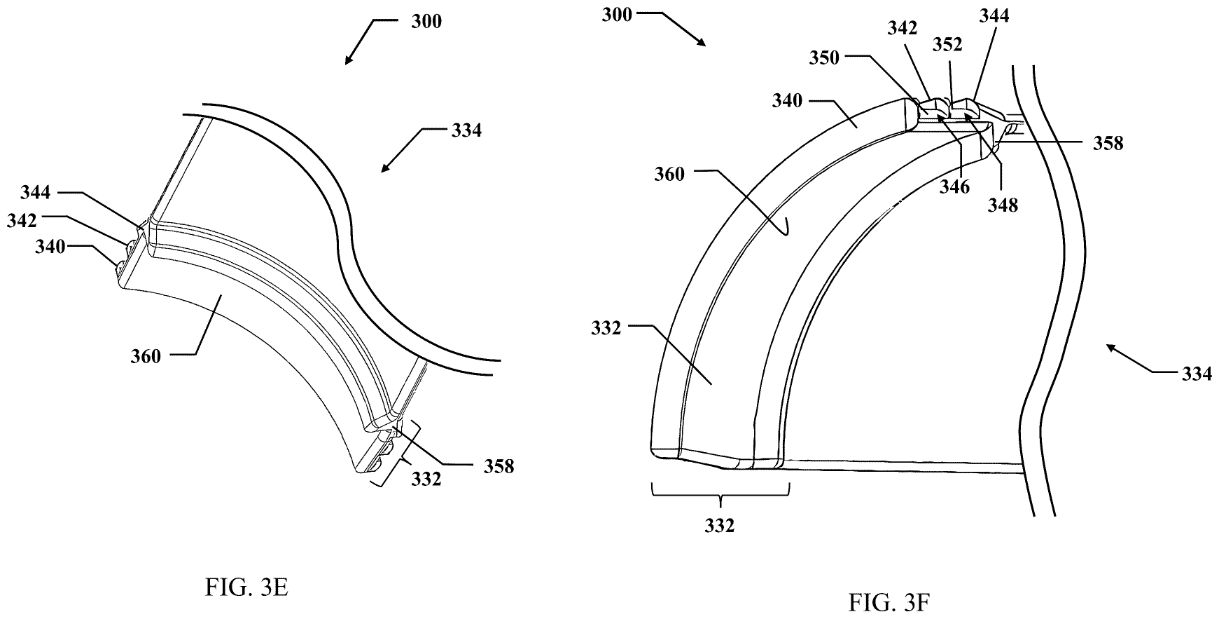

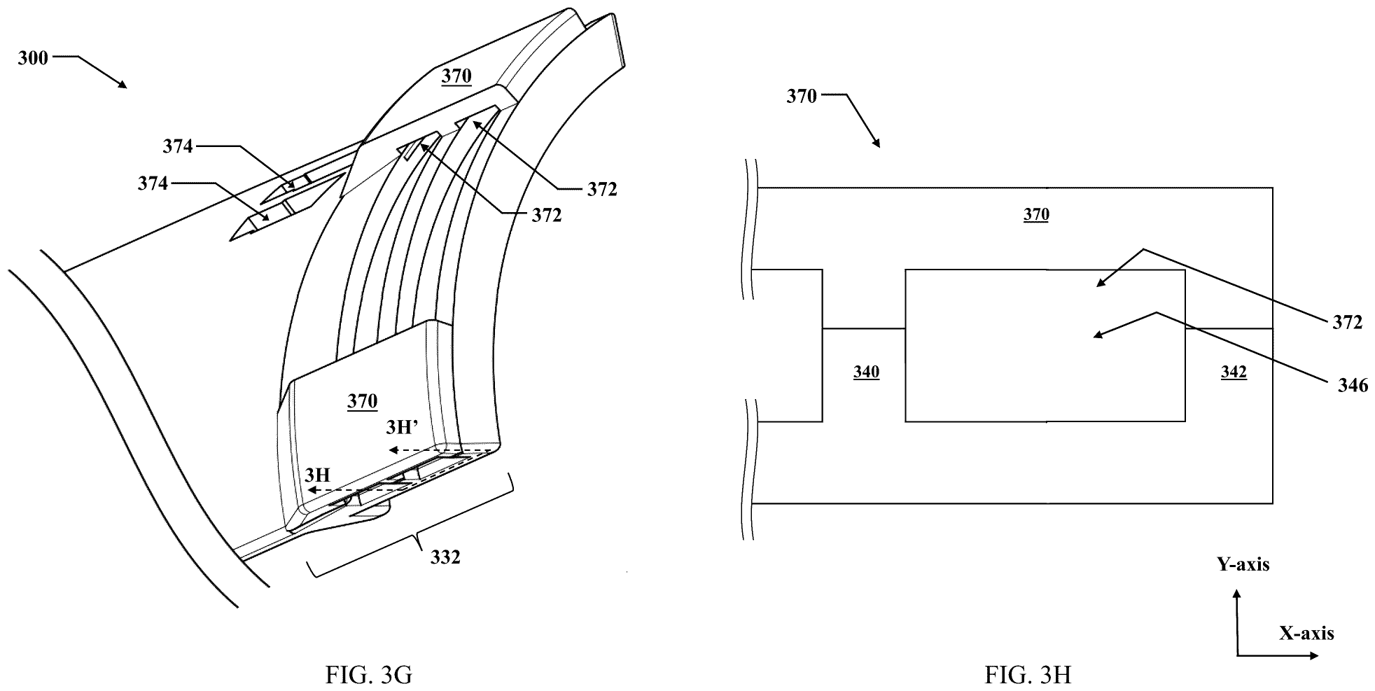

In FIGS. 2A-2B, each of guards 200, 202 is a cylindrical segment. In some embodiments, guards 200, 202 have different lengths. In FIGS. 2A-2B, the length of guard 200 substantially overlaps stanchion 212. In some embodiments, each of guards 200, 202 is constructed from any one or more of numerous alloys or composite materials, including but not limited to materials such as carbon fiber, other polymer matrix composite material, nylon or the like. In some embodiments, guard 200, 202 is constructed from resin using 3D printing techniques including but not limited to Selective Laser Sintering, Stereolithography, Digital Light Processing, and Fused Deposit Modeling. Appropriate materials balance rigidity for structural integrity against resiliency/flexibility for impact resistance. In some embodiments, guard 200, 2020 includes a layer less than 0.25 millimeters thick of high-durometer rubber or rubber-like material lining the mounting surface (360 FIG. 3B).

In an example of a lower-mounting embodiment, e.g., as with guards 200, 202 in FIGS. 2A-2B, the guard is mounted to an upper end of the lower outer tube (e.g., 216, 218) such that most of the guard is cantilevered as it extends toward the corresponding shoulder (e.g., 224, 226) of the crown (e.g., 210). As an example of an upper-mounting embodiment (not shown) (and which assumes the non-inverted fork architecture), the guard is mounted to the shoulder (e.g., 224, 226) of the crown (e.g., 210) such that most of the guard is cantilevered as it extends toward the upper end of lower outer tube 216. In each of the lower-mounting and upper-mounting embodiments, the mounting arrangement is removeable such that the guard can be replaced when the guard is damaged. Further, each of the lower-mounting and the upper-mounting embodiments mount the guard in an approximately coaxial orientation with respect to the corresponding leg (e.g., 206, 208). For each of the lower-mounting and upper-mounting embodiments, in some embodiments, the guard has apertures 374 as seen in FIG. 3G for purposes, e.g., of allowing cooling air to pass through to the stanchion, for aesthetics, or the like.

In FIG. 2A, which shows assembly 204 as being fully extended, each of guards 200, 202 is at a default distance from the ground. During compression, stanchions 212, 214 travel coaxially in/out of corresponding lower tubes 216, 218. During full extension, for both the lower-mounting and upper-mounting embodiments and relative to the direction of coaxial travel, substantially no part of each of guards 200, 202 extends beyond the dimensions of assembly 204, i.e., extends beyond corresponding shoulders 224, 226. In the example of a lower-mounting embodiment shown in FIG. 2B, which shows assembly 204 as being compressed, a portion of each of guards 200, 202 extends beyond corresponding shoulders 224, 226. Some lower-mounting embodiments have an advantage that the guard is disposed farther way from the ground (relative to the default distance/separation) during compression of assembly 204 as seen in FIG. 2B, which lessens the risk of a trail-going type of impact on the guard. Examples of a trail-going type of impact include, e.g., a limb of a bush dragging along the side of the bike during travel, pebble-sized rocks being thrown into the air by a bike further ahead on the trail, or the like. This advantage contributes to the longevity of the replaceable guard.

In some embodiments, shoulder 224 and/or shoulder 226 has a radially extending projection, e.g., a control mechanism for adjusting the dampening strength of the corresponding leg. In such embodiments, the upper portion of guard 200 and/or 202 is flared to avoid colliding with the radially extending projections when assembly 204 is compressed. Such embodiments have an advantage of disposing the guard in a position to protect the otherwise exposed stanchion.

In some lower-mounting embodiments, the upper portion of each of guards 200, 202 that extends outside the dimensions of assembly 204 during compression (“overhanging portion”), if subjected to impact, is more susceptible to being torqued around a fulcrum represented by shoulder 224, 226 than is the remaining portion of guard 200, 202, the latter being the portion that does not extend outside the dimensions of assembly 204 during compression. However, the risk of trail-going type impact is decreased because the overhanging portion is further from the ground. In an accident in which a biker loses balance (which unloads assembly 204 thereby returning the same to full extension) and crashes, or the like, impact of the guard is likely to occur when assembly 204 is at or near full extension. At or near full extension, little if any of either of guards 200, 202 is overhanging with respect to the noted fulcrum, which diminishes the potential risk of guards 200, 202 being torqued around shoulders 223, 226. Additionally, in shorter embodiments of guards 200, 202 (discussed below), little if any of either of guards 200, 202 extends outside the dimensions of assembly 204, diminishing the potential risk of guards 200, 202 being torqued around shoulders 223, 226.

In some upper-mounting embodiments, the lower portion of each of guards 200, 202 does not extend outside the dimensions of suspension fork assembly 204 during compression. If subjected to impact, guards 200, 202 are less suspectable to being torqued around a fulcrum represented by a lower portion of an inverted suspension fork assembly. However, the upper mounting embodiment results in guards 200, 202 being disposed closer to the ground during compression as compared to the lower-mounting embodiment, which exposes guards 200, 202 to a greater risk of trail-going impact, i.e, is less protective of guards 200, 202 themselves.

FIGS. 3A-3B are first side views of correspondingly of an exterior and an interior of a lower-mounting guard 300, in accordance with some embodiments. FIGS. 3C-3D are second side views of correspondingly of an exterior and an interior of a lower-mounting guard 300, in accordance with some embodiments.

FIGS. 3A and 3C are corresponding first and second side views of the exterior of lower-mounting guard 300. Relative to a plane of the page on which each of FIGS. 3A and 3C is drawn being defined by the X-axis and the Y-axis, the second side view of FIG. 3C is rotated 90 degrees counterclockwise about the Z-axis relative to the first side view of FIG. 3A. Relative to a cylindrical coordinate system whose longitudinal axis is coaxial with the cylindrical axis of guard 300, the second side view of FIG. 3C is rotated about 90 degrees azimuthally clockwise relative to the first side view of FIG. 3A.

FIGS. 3B and 3D are corresponding first and second side views of the interior of lower-mounting guard 300. Relative to a plane of the page on which each of FIGS. 3B and 3D is drawn being defined by the X-axis and the Y-axis, the second side view of FIG. 3D is rotated 90 degrees counterclockwise about the Z-axis relative to the first side view of FIG. 3B. Relative to a cylindrical coordinate system whose longitudinal axis is coaxial with the cylindrical axis of guard 300, the second side view of FIG. 3D is rotated about 90 degrees azimuthally counter clockwise relative to the first side view of FIG. 3B.

FIG. 3F is a view at a downward angle of the interior portion of attachment point 332 of lower-mounting guard 300. FIG. 3E is a side view of the interior portion of the lower half of guard 334 including attachment point 332. FIGS. 3E-3F show different perspectives of inner rib 358 of attachment point 332.

In FIGS. 3A-3B, lower-mounting guard 300 is a cylindrical segment having an upper portion 336 and a lower portion 334. Guard 300 is an example of guard 200 of FIGS. 2A-2B. Upper portion of guard 336 includes a flared portion 338. Lower portion 334 includes mounting portion 332 for mounting guard 300 to a suspension fork assembly, e.g., assembly 204 of FIGS. 2A-2B, or the like. Mounting portion 332 includes at least one exterior circumferential channel (e.g., 346) formed by at least two exterior circumferential ribs (e.g., 340, 342), each channel being configured to receive a corresponding removable ligature. In some embodiments, e.g., as in FIGS. 3A-3B, guard 300 includes an additional exterior circumferential rib(s) that form additional exterior circumferential channel(s) to hold an additional removable ligature(s). In FIGS. 3A-3B, mounting portion 332 includes two exterior circumferential channels 346, 348. Channel 346 is formed by circumferential rib 340 and circumferential rib 342. Channel 348 is formed by circumferential rib 342 and circumferential rib 344.

Guard 300 is mounted with at least one removeable ligature, e.g., a zip tie, which is received in a corresponding channel (e.g., 346, 348) and is wrapped around the upper end of the lower outer tube (e.g. 216), i.e., where the latter receives the stanchion (e.g., 212). When tightened, the ligature compresses guard 300 against the upper end of the outer surface of lower outer tube (e.g. 216). The ligature is against a ligature-receiving surface (e.g., 350) of the circumferential channel (e.g., 346). In FIG. 3A, a first ligature (not shown) is disposed against ligature-receiving surface 350 of channel 346 and a second ligature (not shown) is placed on a ligature-receiving surface 352 of channel 348. The ligature(s) holds guard 300 in place so that it maintains axial alignment with respect to the lower tube (e.g., 216) and does not rotate azimuthally around the lower tube (e.g., 216) and thus around the stanchion (e.g., 212). The ligature also increases ease of use for a biker who may need to replace guard 300 when it is damaged. In some embodiments, regarding the mounting of guard 300, an adhesive (e.g. a flexible adhesive strip) is disposed between an inner mounting surface (FIGS. 3B, 2E) guard 300 and the upper end of the outer surface of lower outer tube (e.g. 216), where such adhesive is used in addition to or in place of the ligatures.

In FIGS. 3A-3B, upper portion 336 and lower portion 334 of the cylindrical segment, i.e., of guard 300, overlap corresponding first and second circumferential areas of a leg (e.g., 206, 208) of the suspension fork assembly (e.g., 206). Relative to a cylindrical coordinate system whose longitudinal axis is coaxial with the cylindrical axis of guard 300, the first and second circumferential areas correspond to a first range 354 of azimuth angles (azimuthal range), 354 of lower portion 334 (represented by a variable Φ1) and a second azimuthal range 356 of upper portion 336 (represented by a variable Φ2). In FIGS. 3A-3G, a midpoint of second azimuthal range 356 is rotated azimuthally relative to a midpoint of first azimuthal range 354. In some embodiments, the midpoint of second azimuthal range 356 being rotated azimuthally relative to the midpoint of first azimuthal range 354 is described as second azimuthal range 356 being azimuthally offset (represented by a variable Δ) from first azimuthal range 354. In some embodiments (not shown), relative to units of degrees (°), the midpoint of second azimuthal range 356 is aligned azimuthally relative to the midpoint of first azimuthal range 354, i.e., the midpoint of second azimuthal range 356 is not rotated azimuthally relative to the midpoint of first azimuthal range 354 such that Δ≈0°.

Regarding embodiments of guards in which second azimuthal range 356 is azimuthally offset from first azimuthal range 354, e.g., guard 300 in FIGS. 3A-3G, the guard is described as helical. In FIGS. 3A-3G, an example of the azimuthal offset is Δ≈90°. In some embodiments, the azimuthal offset is in a range (≈45°)≤Δ≤(≈135°) Regarding embodiments of a helical guard, e.g., guard 300, a first circumferential area of the leg (e.g., 206, 208) overlapped by lower portion 334 of the cylindrical segment, i.e., of guard 300, is different than the second circumferential area of the leg overlapped by upper portion 336 of the cylindrical segment.

In some embodiments, lower half 334 of the cylindrical segment, i.e., guard 300, extends circumferentially around the stanchion (e.g., 212) to protect the stanchion from damage. In FIGS. 3A-3G, an example of first azimuthal range 354 is shown as Φ1 (≈75°), and an example of second azimuthal range 356 is shown as Φ2 (≈160°). In some embodiments, first azimuthal range 354 is (≈45°)≤Φ1≤(≈105°). In some embodiments, second azimuthal range 356 is (≈240°)≤Φ2≤(≈270°). In some embodiments, first azimuthal range 354 and second azimuthal range 356 are about the same, Φ1≈Φ2. In some embodiments (≈45°)≤(Φ1≈Φ2)≤(≈105°).

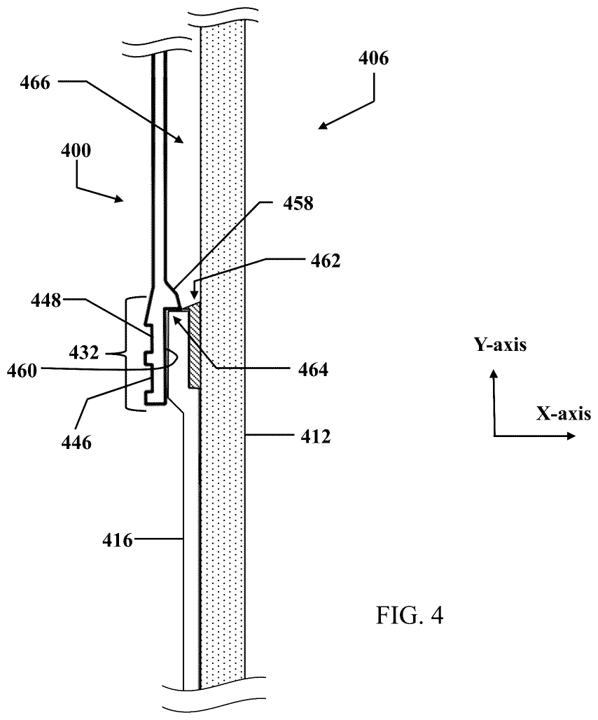

In FIGS. 3B, 3D and 3E-3F, the interior of mounting portion 332 of guard 300 includes a rib 358 configured to register with a corresponding registration feature (464 FIG. 4) of the first or second leg of the suspension fork assembly.

The interior of mounting portion 332 further includes a mounting surface 360 which intersects interior rib 358 which extends radially inward relative to each of mounting surface 360 and the cylindrical axis. When tightened, the ligature(s) disposed in channel 346 and/or 348 exerts a force radially inward upon mounting portion 332 such that mounting surface 360 is urged towards the outer surface of the lower outer tube (e.g., 216). In some embodiments, when tightened, the force exerted by the ligature(s) disposed in channel 346 and/or 348 result in mounting surface 360 being abutted against the outer surface of the lower outer tube (e.g., 216).

FIGS. 3G and 3H are views of a cover 370 for guard 300, in accordance with some embodiments.

In some embodiments, mounting portion 332 of guard 300 includes one or more covers 370 as shown in FIG. 3G. In FIG. 3G, covers 370 are disposed on corresponding ends of the circumference of guard 300. In some embodiments, one or more covers 370 are disposed at circumferential locations other than as shown in FIG. 3G. Where a width of cover 370 is defined as an arc length along an arc represented by a circumferential groover (e.g., 346, 348), various widths of cover 370 are contemplated. Each cover 370 defines a corresponding tunnel 372.

In FIG. 3G, guard 300 has apertures 374 for purposes, e.g., of allowing cooling air to pass through to the stanchion, for aesthetics, or the like. In some embodiments, guard 300 does not have aperture(s) 374.

FIG. 3H is a cross sectional view of cover 370 and guard 300 which corresponds to section line 3H-3H′ in FIG. 3G. Relative to the X-axis in FIG. 3H, legs of cover 370 align with circumferential ribs 340, 342 to enclose channel 346 and thereby define tunnel 372. In FIG. 3H, a shape of tunnel 372 is rectangular. In some embodiments, the shape of tunnel 372 is something other than rectangular. Tunnel 372 prevents a removable ligature disposed in channel 346 from escaping channel 346 relative to the Y-axis in FIG. 3A. Relative to the Y-axis in FIG. 3H, Relative to the Y-axis in FIG. 3H, a height of cover 370 is about the same as a height of mounting portion 332. In some embodiments, the height of cover 370 is different than the height of mounting portion 332. In some embodiments, cover 370 is a separate structure that fits against circumferential ribs 340, 342. In some embodiments, cover 370 and circumferential ribs 340, 342 are of integral construction. A ligature placed in channel 346 is into and through tunnel 372 before the ligature is tightened to secure guard 300 to a stanchion.

FIG. 4 is a cross sectional view of a guard 400 as mounted on a left leg 406 of the suspension fork assembly, in accordance with some embodiments.

An inner rib 458 is configured to register with, i.e., fit against a corresponding registration feature 464 as complementary shapes. Relative to a long axis of guard 400 which is parallel to a first direction (e.g., parallel to the Y-axis in FIG. 4), mounting surface 460 is substantially parallel to the Y-axis. The long axis of guard 400 is substantially parallel to a corresponding long axis of each of stanchion 412 and lower tube 416.

Inner rib 458 projects from the body of guard 400 in a second direction perpendicular (e.g., parallel to the X-axis in FIG. 4) to the first direction. A first side of inner rib 458 extends perpendicularly from mounting surface 460, i.e., extends parallel to the X-axis, which forms a concave corner, which is a complementary shape with respect to the concave corner of guard 400. Registration feature 464 represents an upper end of a lower tube 416. Registration feature 464 includes a first surface parallel to mounting surface 460 and a second surface that perpendicularly intersects the first surface of registration feature 464 to form a convex corner. The second surface of registration feature 464 is parallel to the first side of inner rib 458.

In FIG. 4, inner rib 458 has a second side that intersects the first side. The second side is shown as a compound beveled surface including first and second faces. The first face of beveled surface intersects the first side of inner rib 458 at a positive angle Θ1 that is less than about 90 degrees (≈90°), i.e., Θ1<(≈90°). The second face of the beveled surface intersects the first face of the beveled surface at an angle Θ2 in a range (0°)<Θ2<(≈90°).

In some embodiments (not shown), the second side of inner rib 458 has a simple beveled surface that includes only a single face. In some embodiments (not shown), the second side of inner rib 458 is a chamfered surface. In some embodiments (not shown), the second side of inner rib 458 has an approximately squared (squarish) surface that includes first and second faces. The first face of the squarish surface intersects substantially perpendicularly with the first side of inner rib 458 to define a first convex corner of inner rib 458. The second face of the squarish surface intersects substantially perpendicularly with the first face to define a second convex corner of inner rib 458.

When guard 400 is placed against leg 406, the first side of inner rib 458 abuts registration feature 464 and mounting surface 460 abuts the first surface of registration feature 464 of lower tube 416. Inner rib 458 improves ease of use by ensuring guard 400 is placed where stanchion 412 slides into lower tube 416. When the ligature(s) disposed in channel 446 and/or 448 is tightened, mounting surface 460 is forced against the first surface of registration feature 464 of lower outer tube 416. Inner rib 458 prevents movement of mounting portion 432 once the ligature(s) is tightened.

In some embodiments, the placement of mounting portion 432 of guard 400 against lower tube 416 has a further advantage of reducing the exposure of the open end of circumferential groove 462 to dust and/or or dirt. A gasket (220 FIG. 2A) is disposed in circumferential groove 462. Dust and/or dirt trapped between the gasket and stanchion 412 can become abrasive and increase friction with respect to stanchion 412. Trapped dust and/or dirt can also contaminate lubricant present between stanchion 412 and lower tube 416 and promote corrosion of stanchion 412.

In FIG. 4, there is a gap 466 between guard 400 and stanchion 412. Gap 466 is present in both the upper-mounting embodiments and the lower-mounting embodiment of guard 400. Gap 466 provides space in which guard 400 can flex or twist as needed to protect stanchion 412 from damage.

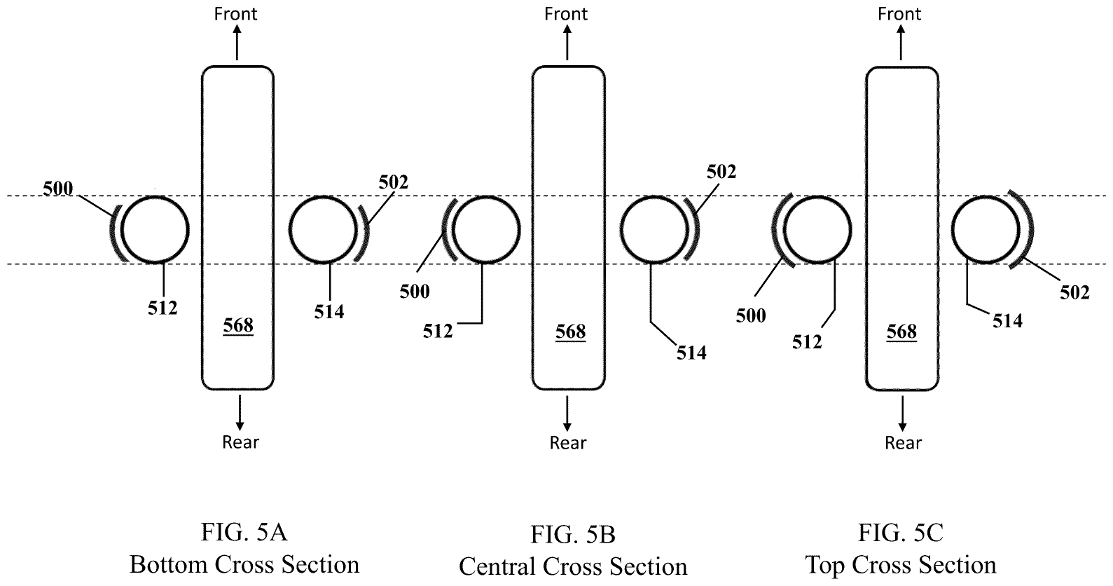

FIGS. 5A-C are corresponding cross sectional views of a mounted guard 500, in accordance with some embodiments.

In addition to guards 500, 502, each of FIGS. 5A-SC further includes stanchions 512, 514 and a tire 568. Guards 500, 502 are corresponding examples of guards 200, 202 of FIGS. 2A-2B. Stanchions 512, 514 are corresponding examples of stanchions 212, 214 of FIGS. 2A-2B. Tire 568 is an example of tire 105F of FIG. 1.

FIG. 5A corresponds to section line 5A-5A′ in FIG. 2A, where section line 5A-5A′ passes through (among other things) the lower portion of guards 200, 202. FIG. 5B corresponds to section line 5B-5B′ in FIG. 2A, where section line 5B-5B′ passes through (among other things) a central portion of guards 200, 202. FIG. 5C corresponds to section line 5C-5C′ in FIG. 2A, where section line 5A-5A′ passes through (among other things) the upper portion of guards 200, 202.

In FIG. 5A, the bottom portion of guards 500, 502 overlap a lower circumferential area of stanchions 512, 514. FIG. 5B shows the cross section of the central portion of guards 500, 502 as guards 500, 502 rotate around the suspension fork leg. FIG. 5C shows the top portion of guards 500, 502 that overlap an upper circumferential area of stanchions 512, 514. The top portion of guards 500, 502 generally face outwards at the front of the suspension fork and then helically wrap around stanchions 512, 514 until the bottom portion of guards 500, 502 generally face out towards the left and right sides of the bicycle as seen in FIG. 5A.

In one version of the lower-mounting embodiment, the mounting portion represents a fulcrum relative to which a majority of the guard is cantilevered. The upper portion of guards 500, 502 overlap larger circumferential areas of stanchions 512, 514 than lower portions of the guards 500, 502.

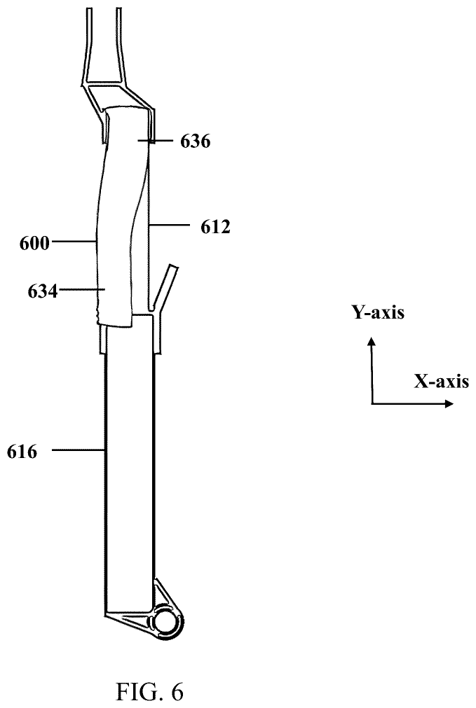

FIG. 6 is a left side view of a guard 600, as mounted in accordance with some embodiments.

In FIG. 6, the length of guard 600 covers the full length of stanchion 612. In some embodiments, the length of guard 600 differs from what is shown in FIG. 6, e.g., such that guard 600 extends past the full length of stanchion 612 and covers the crown when the suspension fork assembly is uncompressed. In some embodiments, the length of guard 600 differs from what is shown in FIG. 6 such that guard 600 only partially covers the full length of stanchion 612. The length of guard 600 includes the length of lower portion 634 and the length of upper portion 636, the latter being cantilevered. The length of the guard may be varied to accommodate different bicycle suspension forks or biker preferences. In some embodiments, a shorter guard is lighter in weight (relative to a longer guard) but nevertheless protects a vulnerable part of the stanchion, the latter being the portion of stanchion 612 that is slidably inserted into outer tube 616 but which is exposed in an uncompressed state of the suspension fork assembly as seen in FIG. 2A).

In terms of length relative to the Y-axis in FIG. 6, an example of a longer guard is a full-length embodiment of guard 600 shown in FIG. 6. In some full length embodiments, a ratio of lower portion 634 to upper portion 636 is about 1:1 (+/−(≈0.15)) depending on the length of stanchion 612 that is not covered by guard 600. The length of stanchion 612 that remains uncovered represents the length of suspension travel, where the latter varies depending upon design considerations of the suspension fork assembly, the size of the bicycle's frame (101 FIG. 1) (in terms of the height of a biker which the frame can comfortably accommodate), or the like. In some embodiments, the length of suspension travel is about 30 millimeters.

In terms of length relative to the Y-axis in FIG. 6, in some embodiments, the guard 600 does not cover the full length of the corresponding portions of stanchion 612 that are overlapped by guard 600. In some embodiments, guard 600 covers no more than about 50% of the length of the stanchion's corresponding portion. Accordingly, the length of upper portion 636 would be up to half the length of the full-length embodiment of upper portion 636. Lower portion 634 would remain the same length. As such, length ratio of lower portion 634 to upper portion 636 would be about 1:0.4 (+/−(≈0.15)) for a shorter embodiment of guard 600.

In some embodiments, a guard (for a suspension fork assembly) includes: a cylindrical segment having an inner surface mountable against a first or second leg of the suspension fork assembly, the first and second legs extending from corresponding shoulders of a crown of the suspension fork assembly; the cylindrical segment having a first portion and a second portion; relative to an outer surface of the cylindrical segment, the lower portion including first and second outer circumferential ribs that form a circumferential channel; the circumferential channel being configured to receive a removeable ligature by which the guard is removably mounted to the first or second leg of the suspension fork assembly.

In some embodiments, the first and second portions of the cylindrical segment overlap corresponding first and second circumferential areas of the first or second leg of the suspension fork assembly; relative to a cylindrical coordinate system having a longitudinal axis which is coaxial with a cylindrical-axis of the guard, the first and second circumferential areas correspond to first and second ranges of azimuth angle (azimuthal ranges); and the cylindrical segment is helical such that the first azimuthal range corresponding to the first circumferential area overlapped by the second portion is different than the second azimuthal range corresponding to the second circumferential area overlapped by the first portion.

In some embodiments, the circumferential channel is included in the mounting portion of the cylindrical segment and the mounting portion is configured to be removably disposed against the first or second leg such that the cylindrical segment is disposed in an approximately coaxial orientation with respect to the first or second leg.

In some embodiments, the mounting portion represents a fulcrum relative to which the majority of the cylindrical segment is cantilevered.

In some embodiments, the first and second portions of the guard extend from a central region of the cylindrical segment, and relative to the central region, a distal end of the first portion is flared to avoid colliding with a radially-extending projection of the first or second leg of the suspension fork assembly during compression of the suspension fork assembly.

In some embodiments, during part of a duration in which the suspension fork assembly is variably compressed, and relative to a direction parallel with a cylindrical axis of the guard, a correspondingly variable percentage of the first portion of the guard is extended beyond a shoulder of the suspension fork assembly.

In some embodiments, the inner surface of the second portion of the cylindrical segment includes an inner rib configured to register correspondingly with a registration feature of the first or second leg of the suspension fork assembly.

In some embodiments, each of the first and second legs include an outer tube and an inner tube. Relative to a direction parallel with a cylindrical axis of the guard, the inner tube is slidably insertable into the corresponding outer tube. Each outer tube of the first and second legs correspondingly includes a registration feature, and for each outer tube, the registration features is proximal to a sealing arrangement between the outer tube and the corresponding inner tube. The second portion of the cylindrical segment is positioned to protect the sealing arrangement.

In some embodiments, the guard includes at least one cover that is over a corresponding portion of the circumferential channel (corresponding covered portion of the circumferential channel) and each cover and corresponding covered portion of the circumferential channel define a corresponding tunnel and each tunnel is configured to receive the removable ligature.

In some embodiments, the second portion of the cylindrical segment contains apertures.

In some embodiments, a guard (for a suspension fork assembly) includes: a cylindrical segment having an inner surface mountable against a first or second leg of the suspension fork assembly, the first and second legs extending from corresponding shoulders of a crown of the suspension fork assembly; the cylindrical segment having a first portion and a second portion; relative to an outer surface of the cylindrical segment, the second portion including first and second outer circumferential ribs that form a circumferential channel; the circumferential channel being configured to receive a removeable ligature by which the guard is removably mounted to the first or second leg of the suspension fork assembly. The first and second portions of the cylindrical segment overlap corresponding first and second circumferential areas of the first or second leg of the suspension fork assembly; relative to a cylindrical coordinate system having a longitudinal axis which is coaxial with a cylindrical-axis of the guard, the first and second circumferential areas correspond to first and second ranges of azimuth angle (azimuthal ranges); and the cylindrical segment is helical such that the first azimuthal range corresponding to the first circumferential area overlapped by the second portion is different than the second azimuthal range corresponding to the second circumferential area overlapped by the first portion.

In some embodiments, a guard (for a suspension fork assembly) includes: a cylindrical segment having an inner surface mountable against a first or second leg of the suspension fork assembly, the first and second legs extending from corresponding shoulders of a crown of the suspension fork assembly; the cylindrical segment having a first portion and a second portion. The first portion and the second portion extend from a central region of the cylindrical segment and relative to the central region, a distal end of the first portion is flared to avoid colliding with a radially-extending projection of the first or second leg of the suspension fork assembly during compression of the suspension fork assembly. The lower portion further includes a mounting portion of the cylindrical segment, and the mounting portion represents a fulcrum relative to which a majority of the cylindrical segment is cantilevered.

It will be readily seen by one of ordinary skill in the art that one or more of the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A guard for a suspension fork assembly, the guard comprising:
a cylindrical segment having an inner surface mountable against a first or second leg of the suspension fork assembly, the first and second legs extending from corresponding shoulders of a crown of the suspension fork assembly;
the cylindrical segment having a first portion and a second portion;
relative to an outer surface of the cylindrical segment, the second portion including first and second outer circumferential ribs that form a circumferential channel;
the circumferential channel being configured to receive a removeable ligature by which the guard is removably mounted to the first or second leg of the suspension fork assembly.

2. The guard of claim 1, wherein:
the first and second portions of the cylindrical segment overlap corresponding first and second circumferential areas of the first or second leg of the suspension fork assembly;
relative to a cylindrical coordinate system having a longitudinal axis which is coaxial with a cylindrical-axis of the guard, the first and second circumferential areas correspond to first and second ranges of azimuth angle (azimuthal ranges); and
the cylindrical segment is helical such that the first azimuthal range corresponding to the first circumferential area overlapped by the second portion is different than the second azimuthal range corresponding to the second circumferential area overlapped by the first portion.

3. The guard of claim 1, wherein:
the circumferential channel is included in a mounting portion of the cylindrical segment; and
the mounting portion is configured to be removably disposed against the first or second leg such that the cylindrical segment is disposed in an approximately coaxial orientation with respect to the first or second leg.

4. The guard of claim 3, wherein:
the mounting portion represents a fulcrum relative to which a majority of the cylindrical segment is cantilevered.

5. The guard of claim 1, wherein:
the first and second portions extend from a central region of the cylindrical segment; and
relative to the central region, a distal end of the first portion is flared to avoid colliding, during compression of the suspension fork assembly, with a radially-extending projection correspondingly of the first or second leg of the suspension fork assembly.

6. The guard of claim 1, wherein:
during a part of a duration in which the suspension fork assembly is variably compressed, and relative to a direction parallel with a cylindrical axis of the guard, a correspondingly variable percentage of the first portion is extended beyond a shoulder of the suspension fork assembly.

7. The guard of claim 1, wherein:
relative to the inner surface of the cylindrical segment, the second portion of the cylindrical segment includes an inner rib configured to register correspondingly with a registration feature of the first or second leg of the suspension fork assembly.

8. The guard of claim 7, wherein:
each of the first and second legs includes an outer tube and an inner tube;
relative to a direction parallel with a cylindrical axis of the guard, the inner tube is slidably insertable into the corresponding outer tube;
each outer tube of the first and second legs correspondingly includes the registration feature;
for each outer tube, the registration feature is proximal to a sealing arrangement between the outer tube and the corresponding inner tube; and
the second portion of the cylindrical segment is positioned to protect the sealing arrangement.

9. The guard of claim 1, the guard further comprising:
at least one cover; and
wherein:
each cover is over a corresponding portion of the circumferential channel (corresponding covered portion of the circumferential channel);
each cover and the corresponding covered portion of the circumferential channel define a corresponding tunnel; and
each tunnel is configured to receive the removable ligature.

10. The guard of claim 1, wherein:
the second portion of the cylindrical segment contains apertures.

11. A guard for a suspension fork assembly, the guard comprising:
a cylindrical segment having an inner surface mountable against a first or second leg of the suspension fork assembly, the first and second legs extending from corresponding shoulders of a crown of the suspension fork assembly;
the cylindrical segment having a first portion and a second portion;
relative to an outer surface of the cylindrical segment, the second portion including first and second outer circumferential ribs that form a circumferential channel;
the circumferential channel being configured to receive a removeable ligature by which the guard is removably mounted to the first or second leg of the suspension fork assembly, and
the circumferential channel being included in a mounting portion of the cylindrical segment,
the mounting portion being configured to be removably disposed against the first or second leg such that the cylindrical segment being disposed in an approximately coaxial orientation with respect to the first or second leg, and
relative to the inner surface of the cylindrical segment, the second portion of the cylindrical segment including an inner rib configured to register correspondingly with a registration feature of the first or second leg of the suspension fork assembly.

12. The guard of claim 11, wherein:
the first and second portions of the cylindrical segment overlap corresponding first and second circumferential areas of the first or second leg of the suspension fork assembly;
relative to a cylindrical coordinate system having a longitudinal axis which is coaxial with a cylindrical-axis of the guard, the first and second circumferential areas correspond to first and second ranges of azimuth angle (azimuthal ranges); and
the cylindrical segment is helical such that the first azimuthal range corresponding to the first circumferential area overlapped by the second portion is different than the second azimuthal range corresponding to the second circumferential area overlapped by the first portion.

13. The guard of claim 11, wherein:
during a part of a duration in which the suspension fork assembly is variably compressed, and relative to a direction that is substantially parallel to a cylindrical axis of the guard, a correspondingly variable percentage of the first portion is extended beyond a shoulder of the suspension fork assembly.

14. The guard of claim 11, wherein:
the mounting portion represents a fulcrum relative to which a majority of the cylindrical segment is cantilevered.

15. The guard of claim 11, wherein:
the first and second portions extend from a central region of the cylindrical segment; and
relative to the central region, a distal end of the first portion is flared to avoid colliding, during compression of the suspension fork assembly, with a radially-extending projection of the first or second leg of the suspension fork assembly.

16. The guard of claim 11, wherein:
relative to the inner surface of the cylindrical segment, the second portion of the cylindrical segment includes an inner rib configured to register correspondingly with a registration feature of the first or second leg of the suspension fork assembly.

17. The guard of claim 11, wherein:
each of the first and second legs includes an outer tube and an inner tube;
relative to a direction parallel with a cylindrical axis of the guard, the inner tube is slidably insertable into the corresponding outer tube;
each outer tube of the first and second legs correspondingly includes the registration feature;
for each outer tube, the registration feature is proximal to a sealing arrangement between the outer tube and the corresponding inner tube; and
the second portion of the cylindrical segment is positioned to protect the corresponding sealing arrangement.

18. A guard for a suspension fork assembly, the guard comprising:
a cylindrical segment having an inner surface mountable against a first or second leg of the suspension fork assembly, the first and second legs extending from corresponding shoulders of a crown of the suspension fork assembly;
the cylindrical segment having a upper portion and a lower portion;
the upper and lower portions extend from a central region of the cylindrical segment; and
relative to the central region, a distal end of the upper portion is flared to avoid colliding, during compression of the suspension fork assembly, with a radially-extending projection of the first or second leg of the suspension fork assembly; and
the lower portion includes a mounting portion of the cylindrical segment,
wherein the mounting portion represents a fulcrum relative to which a majority of the cylindrical segment is cantilevered.

19. The guard of claim 18, wherein:
the mounting portion is configured to be removably disposed against the first or second leg such that the cylindrical segment is disposed in an approximately coaxial orientation with respect to the first or second leg.

20. The guard of claim 18, wherein;
during a part of a duration in which the suspension fork assembly is variably compressed, and relative to a direction parallel with a cylindrical axis of the guard, a correspondingly variable percentage of the upper portion is extended beyond a shoulder of the suspension fork assembly.
